(19) United States
(12) Patent Application Publication
(10) Pub. No.: US 2005/0260323 A1
(43) Pub. Date: Nov. 24, 2005

(54) Effervescent drink product and method of creation

(75) Inventors: Joseph P. Sperling, Plymouth, MN (US); Matthew G. Parrish, Hamel, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: TARGET BRANDS, INC.

(21) Appl. No.: 10/852,089

(22) Filed: May 24, 2004

(51) Int. Cl. A23G 3/00

(52) U.S. Cl. 426/590

(57) ABSTRACT

An effervescent drink product includes a beverage and a plurality of effervescent confectionaries suspended by the beverage. Each of a first portion of the effervescent confectionaries is adapted to pop due to contact with the beverage. Each of a second portion of the effervescent confectionaries is adapted to pop during subsequent consumption of the beverage.

### BACKGROUND OF THE INVENTION

Consumers frequently purchase individual servings of refreshments or drinks at retail locations such as discount or department stores, restaurants, convenience stores, fast food stores, movie theaters, food courts, etc. Refreshments or drinks offered by retail locations include frozen but flowable beverages, carbonated beverages, soft drinks, and the like. Although some consumers purchase refreshments or drinks due to hunger or thirst, many consumers purchase refreshments or drinks as an impulse purchase upon seeing the refreshment product on marketing material, on a menu, etc. This is particularly true for unusual refreshment products that can only be purchased at a particular retail location, during a particular season or promotion, etc., or products offering some point of uniqueness or excitement. As such, retail locations can benefit from offering fun and exciting products to consumers.

### SUMMARY OF THE INVENTION

One embodiment of the present invention relates to an effervescent drink product including a beverage and a plurality of effervescent confectioneries suspended by the beverage. Each of a first portion of the effervescent confectionaries is adapted to pop due to contact with the beverage. Each of a second portion of the effervescent confectionaries is adapted to pop during subsequent consumption of the beverage.

### BRIEF DESCRIPTION OF THE DRAWINGS

Embodiments of the invention will be described with respect to the figures, in which like reference numerals denote like elements, and in which:

FIG. 1 is a perspective view of an effervescent drink product, according to an embodiment of present invention.

FIG. 2 is a perspective view of a container and a cover of the effervescent drink product of FIG. 1.

FIG. 3 is a flow chart illustrating a method of providing an effervescent drink product, according to one embodiment of the present invention.

FIG. 4 is a perspective view of an effervescent drink product, according to one embodiment of the present invention.

FIG. 5A is a cross-sectional view of an effervescent drink product taken along the line 5-5 of FIG. 4, according to one embodiment of the present invention.

FIG. 5B is a cross-sectional view of an effervescent drink product taken along the line 5-5 of FIG. 4, according to one embodiment of the present invention.

FIG. 6 is a perspective view of an effervescent drink product, according to one embodiment of the present invention.

### DETAILED DESCRIPTION

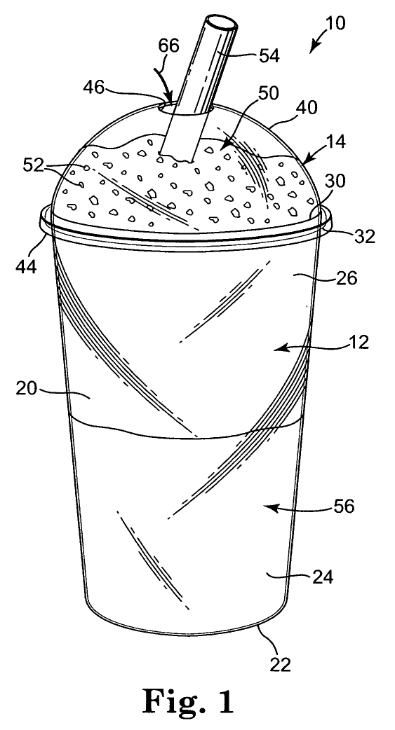

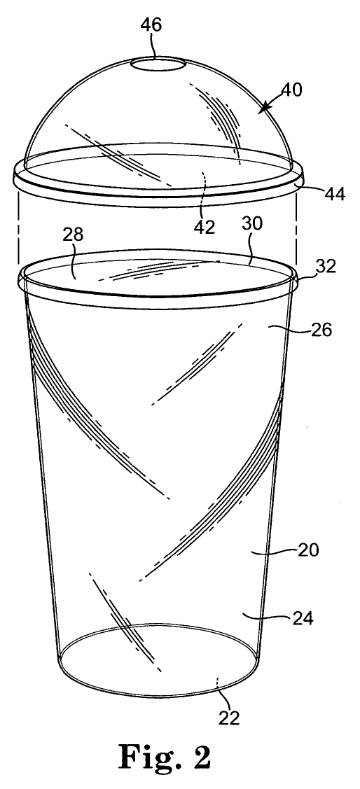

FIGS. 1 and 2 illustrate one embodiment of an effervescent drink product or refreshment product 10 including a container or cup 12 maintaining an effervescent refreshment 14 for consumer consumption. Container 12 includes a side wall 20 and a bottom wall 22. As will be described below, container 12, in particular, side wall 20 thereof, can assume a wide variety of forms. In one embodiment, side wall 20 is substantially frusto-conical in shape and defines a bottom end 24 and a top end 26. Side wall 20 defines a larger cross-sectional area near top end 26 than the cross-sectional area defined near bottom end 24. In one embodiment, side wall 20 is substantially frusto-conical with varying degrees of tapering between bottom end 24 and top end 26, in contrast to the constant tapering of side wall 20 illustrated in FIG. 1. In other embodiments, side wall 20 is formed in another shape, such as cylindrical, triangular, square, polygonal, irregular, etc.

In one embodiment, bottom wall 22 is substantially horizontal when the container 12 is upright. Bottom wall 22 is coupled with and closes side wall 20 at bottom end 24 of side wall 20. Accordingly, side wall 20 and bottom wall 22 collectively define a compartment or chamber 28 and an opening 30 near top end 26 of side wall 20. Opening 30 provides access to compartment 28. In one embodiment, container 12 additionally defines a lip 32 extending radially outward from opening 30. In one embodiment, lip 32 is substantially annular. In one embodiment, side wall 20, bottom wall 22, and/or lip 32 are generally transparent or translucent. In other embodiments, side wall 20 and/or bottom end 24 are at least partially opaque.

In one embodiment, drink or refreshment product 10 additionally includes a domed cover 40 for partially enclosing compartment 28 of container 12. Domed cover 40 is generally dome-shaped or semi-spherical. Domed cover 40 defines an opening 42, a flange 44, and an aperture 46. Opening 42 is defined at the bottom of domed cover 40 and flange 44 extends from opening 42 in a generally outwardly radial and downward direction (i.e., away from the remainder of domed cover 40). In one embodiment, flange 44 is configured to fit over and interact with lip 32 of container 12 to selectively couple domed cover 40 about opening 30 defined by container 12. In one embodiment, domed cover 40 is generally transparent or translucent.

Aperture 46 extends generally through the center of domed cover 40 opposite opening 42. In one embodiment, aperture 46 is sized to allow effervescent refreshment 14 to be dispensed into compartment 28 through aperture 46. Upon coupling of domed cover 40 with container 12, compartment 28 is substantially enclosed except for aperture 46 of domed cover 40.

Compartment 28 is filled with effervescent refreshment 14. In one embodiment, effervescent refreshment 14 entirely fills compartment 28 and, in one embodiment, extends into the spaced defined below or within domed cover 40. Effervescent refreshment 14 includes a drink or beverage 50 and a plurality of effervescent confectionaries 52. In one embodiment, drink 50 is a frozen carbonated beverage such as a cola, a flavored soda, ICEE brand carbonated beverage product, etc. Notably, when generally considered to be frozen, drink 50 maintains a flowable or liquefied state such that drink 50 is drinkable without a spoon or other utensil. In one embodiment, drink 50 is a cool to very cold carbonated beverage, such as a cola, a flavored soda, etc. Drink 50 thus includes cold, very cold, and frozen drinks. Accordingly, in one embodiment, a straw 54 is placed through aperture 46 and into drink 50 to provide easy access to effervescent refreshment 14.

In one embodiment, compartment 28 is entirely filled with a single drink 50. In another embodiment, drink 50 is a first drink and effervescent refreshment 14 additionally includes a second drink or beverage 56. Second drink 56 is similar to drink 50. However, in one embodiment, first drink 50 and second drink 56 each are a different flavor and/or color. Notably, in one embodiment, in which side wall 20 is generally transparent or translucent, a consumer is able to view the colors of drink(s) 50 and or 56 through side wall 20.

In one embodiment, the colors or flavors of each drink 50 and 56 are determined in order to coordinate with a holiday, promotion, theme, celebration, or other event. For example, in one embodiment, the effervescent refreshment 10 is provided near the American Independence Day holiday and, accordingly, first drink 50 is chosen to have a color selected from a group of red, white, and blue, and second drink 56 is selected to have a color selected from the group of red, white, and blue and different from the color of first drink 50.

The plurality of effervescent confectionaries 52 are suspended within first drink 50 and/or second drink 56. In one embodiment, each of the plurality of effervescent confectionaries 52 is or includes carbonated candies, such as POP ROCKS brand candies. In one embodiment, carbonated candies, and therefore effervescent confectionaries 52, are each configured to effervesce (i.e., pop or explode) due to contact with liquid and/or due to exposure to an increase in temperature.

In one embodiment, effervescent confectionaries 52 are formed from a larger effervescent confectionary that comprises sugar, lactose (milk sugar), corn syrup, and flavoring and is processed with carbon dioxide. In particular, the sugar, lactose, corn syrup, and flavoring are heated together and boiled to form a hot sugar mixture. The hot sugar mixture is subsequently mixed with carbon dioxide gas at about 600 PSI. Addition of the carbon dioxide gas forms tiny, 600 PSI bubbles in the effervescent confectionary.

Once the effervescent confectionary cools, the pressure bubbles are released shattering the effervescent confectionary to create a plurality of effervescent confectionary or confectionary pieces 52 ready for consumption, addition to a drink product, or other use. Ultimately, the plurality of effervescent confectionaries 52 melt when exposed to increased temperature or moisture, thereby, releasing remaining carbon dioxide bubbles and creating a pop (i.e. the release or escape of the 600 PSI carbon dioxide gas from each bubble). In one embodiment, a pop is audibly, visually and/or tactiley perceived. In one embodiment, the tactile perception of a pop is of a fizzing sensation. Accordingly, each pop or effervescence is a sensory event.

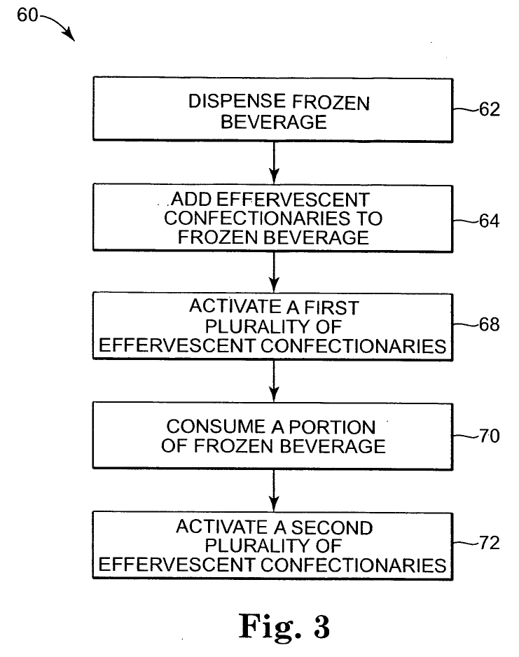

One embodiment of a process of creating and consuming effervescent refreshment 14 is generally illustrated in FIG. 3 at 60. At 62, drink or beverage 50 and/or 56 is dispensed into compartment 28. In one embodiment, second drink 56 is dispensed into compartment 28 through aperture 46 of domed cover 40 at 62 to only partially fill compartment 28. In other embodiments, second drink 56 is dispensed into compartment 28 prior to placement of domed cover 40 upon container 12. In one embodiment, second drink 56 generally fills half of compartment 28. After second drink 56 has been dispensed into compartment 28, first drink 50 is dispensed into compartment 28 through aperture 46 and, accordingly, is layered onto second drink 56. In other embodiments, first drink 50 is dispensed into compartment 28 prior to placement of domed cover 40 upon container 12. Drink 50 is dispensed into compartment 28 until compartment 28 and/or a portion of the area below domed cover 40 is filled with drink 50 and/or 56. In other embodiments, second drink 56 is not present and first drink 50 solely fills compartment 28.

Once drink 50 and/or 56 has been dispensed into compartment 28, effervescent confectionaries 52 are added to beverage or drink 50, at 64, or more particularly, are poured into compartment 28 through aperture 46 of domed cover 40. In one embodiment, the plurality of effervescent confectioneries 52 are dispensed into compartment 28 through aperture 46 as indicated by arrow 66 illustrated in FIG. 2. In one embodiment, effervescent confectioneries 52 are added to drink 50 by a consumer (e.g., at a self-serve station) or by a server or other preparer at a retail location. At 68, due to contact with drink 50, a first portion of the plurality of effervescent confectioneries 52 are activated and, therefore, pop or effervesce substantially immediately (e.g., within five to sixty or more seconds of initial contact between drink 50 and the effervescent confectionaries 52) due to contact with drink 50. The popping of the first portion of the plurality of effervescent confectioneries 52, thereby, provides a first stage of effervescence or popping. In one embodiment, the first portion of the plurality of effervescent confectionaries 52 pop in a visually and audibly perceivable manner.

However, a second portion of the plurality of effervescent confectionaries 52 do not immediately pop or effervesce due to contact with drink 50. This portion of effervescent confectionaries remains embedded within or suspended within or on drink 50 in a non-popped or un-effervesced state. More specifically, the second portion of effervescent confectionaries 52 are cooled by drink 50, thereby generally delaying effervescence of the second portion of effervescent confectionaries 52. In one embodiment, domed cover 40 generally prevents escape of the first portion of the plurality of effervescent confectionaries 52 as they pop, splattering or spilling of drink 50 onto the consumer, and/or overflow of drink 50. In the case of an expanding drink 50, i.e., a drink that increases in volume after it is dispensed into compartment 28, this latter function of domed cover 40 is especially advantageous.

Following or during the popping or effervescence of the first portion of effervescent confectioneries 52 due to contact with drink 50, at 70 a consumer consumes at least a portion of drink 50 by placing at least a portion of drink 50 within his/her mouth via sipping, pouring, straw 54, or other utensil. Note that drink 50 placed within the mouth of the consumer includes a plurality of suspended effervescent confectioneries 52.

At 72, due for example to contact with the mouth of a consumer or melting caused by the increased temperature within the mouth of a consumer, a second plurality of pops are activated. Otherwise stated, a second portion of the plurality of the effervescent confectionaries 52 (i.e. at least a portion of the effervescent confectionaries 52 that did not pop upon initial contact with drink 50 at 68) pop or effervesce due to consumption by the consumer. Accordingly, the second portion of the effervescent confectionaries 52 provides a second stage of effervescence or popping.

In one embodiment, the second stage of effervescence within the mouth of the consumer provides the consumer with both an audible pop and a tactile sensation, as the second portion of the plurality of effervescent confectionaries 52 pop or effervesce. In one embodiment, the effervescence or popping of the effervescent confectioneries 52 within container 12 and within the mouth of the consumer can be viewed or described as the explosion of miniature fireworks. As such, presentation and consumption of effervescent drink product 10 to a consumer provides the consumer with an enjoyable and entertaining effervescent refreshment 14, which delights the sight, sound, and tactile senses in addition to the taste senses of the consumer. Accordingly, the effervescent drink product 10 provides an amusing and delicious effervescent refreshment 14 to the consumer.

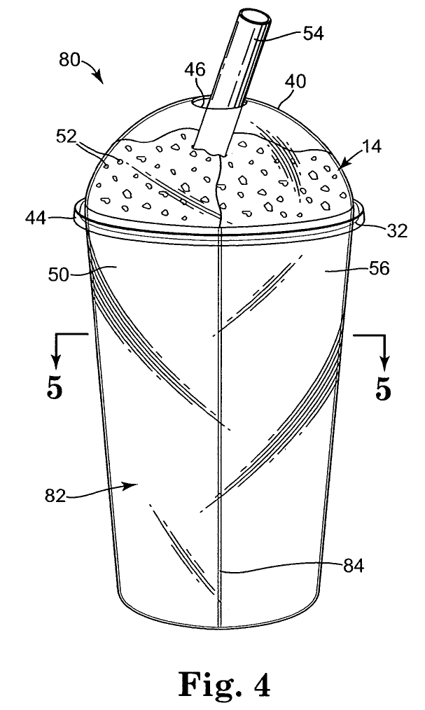

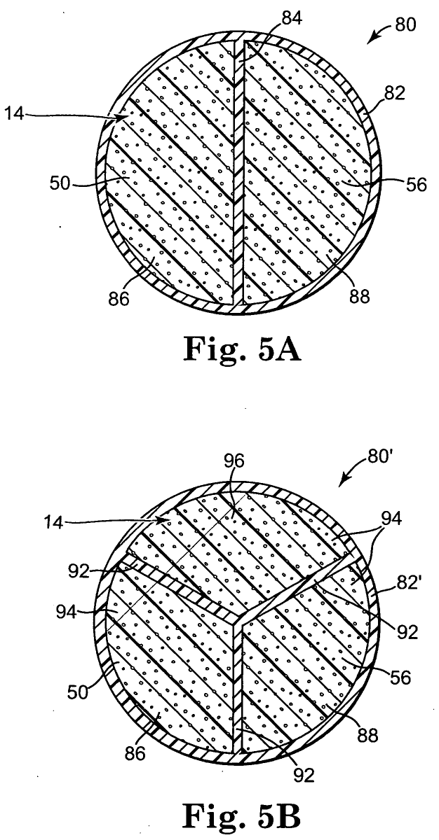

FIGS. 4 and 5A illustrate another embodiment of an effervescent drink product or refreshment product generally at 80. Effervescent drink product 80 is substantially similar to effervescent drink product 10 described above except for those characteristics specifically described herein. Accordingly, effervescent drink product 80 includes a container or a cup 82 and effervescent refreshment 14. Container 82 similarly includes side wall 20, bottom wall 22, and lip 32 as described above. However, container 82 additionally includes a divider 84 extending across the compartment 28 defined by side wall 20. As such, divider 84 divides compartment 28 into a first compartment 86 and a second compartment 88. In one embodiment, divider 84 is integrally formed with side wall 20. In another embodiment, first and second compartment 86 and 88 are formed by inserts (not shown) fit within larger compartment 28 and including divider 84.

Container 82 is fitted with domed cover 40 in a similar manner as described above with respect to container 12. Compartments 86 and 88 are filled with drink 50 and/or drink 56 also as described above. In one embodiment, first compartment 86 is filled with first drink 50 and second compartment 88 is filled with second drink 56. In other embodiments, multiple drinks may be layered within each compartment 86 and 88. Accordingly, effervescent confectioneries 52 are added to first drink 50 and second drink 56. Effervescent drink product 80 is created and drinks 50 and 56 with effervescent confectionaries 52 are consumed in a similar manner as in process 60 described above.

FIG. 5B illustrates an alternate cross-section of effervescent drink product 80 in FIG. 3 generally illustrated at 80′. Effervescent drink product 80′ includes a container or a cup 82′ and effervescent refreshment 14. However, container 82′ includes a plurality of dividers 92 extending throughout the internal compartment 28 of container 82′. In one embodiment, each of the dividers 92 extends from a center of container 82′ in a radially outward manner towards side wall 20. As such, each of the plurality of dividers 92 at least partially defines one of a plurality of compartments 94. In one embodiment, each of the plurality of dividers 92 extends substantially perpendicular to bottom wall 22 of container 82′. In one embodiment, each of the plurality of dividers 92 is integrally formed with side wall 20. In other embodiments, one or each of the plurality of dividers 92 is formed by an insert or inserts (not illustrated), which fit within compartment 28 of container 82′. In one embodiment, container 82′ includes three dividers 92 and three compartments 94.

Each of the plurality of compartments 94 can be filled with one or a plurality of drinks 50 and/or 56 to achieve a desired flavor or color structure. In one embodiment, first drink 50, second drink 56, and a third drink 96, which is similar to drinks 50 and 56, are each contained in a separate compartment 94. In one embodiment, the colors or flavors of drinks 50, 56, and 96 are selected to relate to a holiday, promotion, theme, event, or other celebration. For example, in one embodiment, in honor of a patriotic or other national holiday, drinks 50, 56, and 96 are colored to collectively present the color of a national flag. In one embodiment, for example, first drink 50 is white, second drink 56 is red, and third drink 96 is blue.

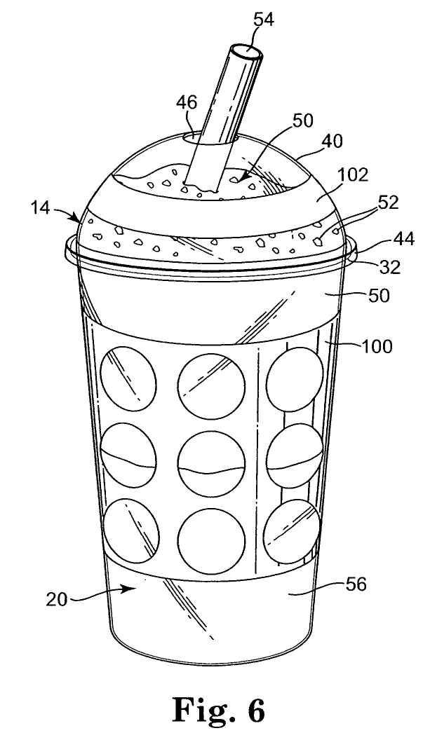

FIG. 6 illustrates another embodiment of effervescent drink product 10 including container 12 and effervescent refreshment 14. In this embodiment, container 12 further includes container indicia 100. In this embodiment, side wall 20 of container 12 is generally transparent or translucent, and container indicia 100 are less transparent or translucent, or are generally opaque. Container indicia 100 are printed or stamped upon side wall 20 of container 12. In one embodiment, container indicia 100 are configured to maintain substantial portions of transparency on side wall 20, such that the color(s) of drink(s) 50, 56, and/or 96 can be viewed by a consumer from positions external to compartment 28. In one embodiment, container indicia 100 are or are placed on a sleeve or wrap that can be generally placed around transparent container 12.

Container 12 with container indicia 100 may be used to indicate brand name, brand identifier, store affiliation, promotion identifier, holiday identifier, logo, trademark, picture, scene, etc. In one embodiment, the color or appearance of container indicia 100 and the color or colors of drink 50, 56, and/or 96 collectively relate to a holiday, promotion, theme, celebration, or other event. In one embodiment, container indicia 100 and the drinks 50, 56, and/or 96 collectively present the colors of a national flag, for example, red, white, and blue. In one embodiment, container indicia 100 and/or cover indica 102 include directions for preparing effervescent drink product 10.

In one embodiment, domed cover 40 additionally includes cover indicia 102. Cover indicia 102 is similar to container indicia 100 but is placed upon domed cover 40 in any desired configuration and color. In one embodiment, cover indicia 102 includes a color or scene relating to brand name, brand identifier, store affiliation, promotion identifier, holiday identifier, logo, trademark, picture, scene, etc. In one embodiment, the color or appearance of cover indicia 102 and the color or colors of drink 50, 56, and/or 96 collectively relate to a holiday, promotion, theme, celebration, or other event. In one embodiment, cover indicia 102 and the drinks 50, 56, and or 96 collectively present the colors of a national flag, for example, red, white, and blue. In one embodiment, effervescent drink product 10 includes both container indicia 100 and cover indicia 102.

As a specific example, a brand identifier of indicia 100 and/or 102 includes the color red. Drink 50 is blue in color and is vanilla or raspberry flavored. Drink 56 is white in color and is cherry flavored. The colors red, white, and blue are thus presented to the consumer. Effervescent confectionaries 52 provide a “fireworks” effect. The combination of the red, white, and blue colors and the fireworks creates an exciting and pleasing overall sensory effect in connection with a holiday, such as the American Independence Day holiday.

According to one embodiment of the invention intended for marketing near the American Independence Day holiday, then both white and blue drinks are deposited in a generally transparent or translucent plastic cup. The two drinks can be layered horizontally; i.e. a first-colored layer placed in the cup first and a second-colored layer placed on top of the first layer. Alternatively, a divider can be placed vertically within the cup to separate the two colors of the drink in a side-by-side configuration. According to embodiments of the invention, the first drink color is blue, and the second drink color is white. The outside of the cup includes red indicia, e.g. in the form of a red store logo. The colors collectively presented thus are red, white and blue.

A package of effervescent confectioneries producing a sound/popping sensation is provided to the consumer of the refreshment or drink. Instructions on the package, cup, signage, or elsewhere indicate that the effervescent confectionaries are to be deposited into the drink present in the cup, for example through a domed but partially open cover or lid. When the effervescent confectionaries contact the drink, a certain number of the effervescent confectionaries “explode” immediately, creating an immediate auditory effect. The domed cover keeps a substantial portion of the exploding effervescent confectioneries and associated drink within the cup. The domed cover also accommodates the expansive nature of the drink as it is dispensed from a dispenser.

The cold temperature of the drink, for example, creates a delaying effect, such that not all of the effervescent confectionaries “explode” immediately. Instead, when the drink is partially consumed, the drink and a portion of the unexploded effervescent confectioneries enter the consumer's mouth. When the drink and unexploded effervescent confectioneries warm up within the consumer's mouth, the effervescent confectionaries “explode” and a delayed tactile/auditory/flavor effect is created within the consumer's mouth. Thus, the consumer enjoys the auditory effect immediately upon depositing the effervescent confectionaries, and a delayed effect, again, due to the reduced-temperature environment of the iced drink product, upon entering the consumer's mouth.

Embodiments of the invention thus provide a “red, white and blue” visual effect, complete with an explosive or “fireworks” effect both at the top of the refreshment product or drink product and within the consumer's mouth. Visual combination with a company logo, color or other indicia on the cup add to the visual effect created.

Although the invention has been described with respect to particular embodiments, such embodiments are for illustrative purposes only and should not be considered to limit the invention. Various alternatives and changes will be apparent to those of ordinary skill in the art. As an example, the various attributes of effervescent drink product 10, 80, and 80′ can be readily interchanged. More specifically, effervescent drink product 10 may incorporate dividers 84 or 92 as well as container indicia 100 and/or cover indicia 102. In addition, various types of drinks 50 may be combined within each individual compartment or within each container as desired by the consumer or vendor. Additional modifications and changes will be apparent to those of ordinary skill in the art.

1. An effervescent drink product comprising:
a beverage; and
a plurality of effervescent confectionaries suspended by the beverage, wherein
each of a first portion of the plurality of effervescent confectionaries is adapted to pop due to contact with the beverage and each of a second portion of the plurality of effervescent confectioneries is adapted to pop during subsequent consumption of the beverage.

2. The effervescent drink product of claim 1, wherein the beverage comprises a carbonated beverage.

3. The effervescent drink product of claim 1, wherein the beverage comprises a frozen beverage.

4. The effervescent drink product of claim 1, wherein the beverage is a first beverage defining a first color and the effervescent drink further comprises a second beverage defining a second color different from the first color.

5. The effervescent drink product of claim 1, wherein the beverage is colored to correspond with at least one of a holiday, promotion, theme, event, and celebration.

6. The effervescent drink product of claim 1, wherein upon introduction of the plurality of effervescent confectionaries to the beverage, the beverage is adapted to cool the second portion of the plurality of the effervescent confectionaries, generally delaying each of the second portion of the plurality of effervescent confectioneries from popping until placed in a mouth of a consumer.

7. The effervescent drink product of claim 1, wherein each of the first portion of the plurality of confectioneries is adapted to pop in an audibly and visibly perceivable manner.

8. The effervescent drink product of claim 1, wherein each of the second portion of the plurality of confectionaries is adapted to pop in an audibly and tactilely perceivable manner.

9. A refreshment product comprising:
a cup including a side wall at least partially defining at least one chamber, the side wall including at least one indicia; and
a drink selectively maintained within the at least one chamber;
wherein the indicia and the drink present a combined appearance relating to at least one of a holiday, promotion, theme, event and celebration.

10. The refreshment product of claim 9, wherein the cup includes a generally transparent side wall.

11. The refreshment product of claim 9, wherein the at least one indicia includes a brand identifier.

12. The refreshment product of claim 11, wherein the indicia and the drink collectively present the colors of a national flag.

13. The refreshment product of claim 9, wherein the cup is generally transparent, the at least one indicia has a first color, and the drink includes at least a second color, the first color and the second color collectively relating to the at least one of a holiday, promotion, theme, event, or celebration.

14. The refreshment product of claim 9, further comprising:
a plurality of carbonated candies added to the drink, wherein the carbonated candies are adapted to provide for a plurality of sensory events both within the chamber and during subsequent consumption.

15. The refreshment product of claim 14, wherein the plurality of sensory events provided within the chamber are audibly and visually perceivable.

16. The refreshment product of claim 14, wherein the plurality of sensory events provided during subsequent consumption are audibly and tactilely perceivable.

17. The refreshment product of claim 14, wherein the cup defines an opening to the chamber, further wherein the refreshment product includes a domed cover selectively affixed to the cup about the opening.

18. The refreshment product of claim 17, wherein the domed cover is adapted to substantially contain the carbonated candies within the chamber.

19. The refreshment product of claim 17, wherein the domed cover includes an aperture for accessing the drink from a point external to the chamber of the cup.

20. The refreshment product of claim 9, wherein the at least one chamber comprises a plurality of chambers within the container.

21. The refreshment product of claim 20, wherein the drink is a first drink disposed in one of the plurality of chambers, further wherein the refreshment product includes a second drink disposed in another of the plurality of chambers.

22. The refreshment product of claim 21, wherein the drink has a first color, and the second drink has a second color different from the first color, further wherein the first color, the second color, and the indicia collectively relate to at least one of a holiday, promotion, theme, event, or celebration.

23. An effervescent refreshment product comprising:
a beverage;
means for containing the beverage; and
means for providing multiple-stage effervescence to the effervescent refreshment product, wherein the means for providing multiple-stage effervescence contacts the beverage.

24. The effervescent refreshment product of claim 23, wherein the means for providing multiple-stage effervescence comprises:
means for providing a first-stage effervescence to the effervescent refreshment product, and
means for providing a second-stage effervescence to the effervescent refreshment product, the second-stage effervescence occurring subsequent to the first stage effervescence;
wherein the means for providing first-stage effervescence and the means for providing second stage effervescence are each placed in contact with the beverage at about the same time.

25. The effervescent refreshment product of claim 23, wherein the means for containing comprises:
means for visually associating with the beverage to present a combined appearance relating to at least one of a holiday, promotion, theme, event, and celebration.

26. A method of creating a drink providing multiple-stage sensory events, the method comprising:
filling a cup with a beverage;
adding a plurality of carbonated candies to the beverage;
activating a first portion of the plurality of carbonated candies causing a first plurality of sensory events at a first stage; and
activating a second portion of the plurality of carbonated candies causing a second plurality of sensory events at a second stage subsequent to the first stage.

27. The method of claim 26, furthering including covering the container to maintain the beverage within the cup during the first plurality of sensory events.

28. The method of claim 26, wherein the first plurality of sensory events include gas escaping from the first portion of the plurality of carbonated candies, and the second plurality of sensory events include gas escaping from the second portion of the plurality of carbonated candies.

29. The method of claim 28, wherein activating a first portion of the plurality of carbonated candies includes gas escaping from the first portion of the plurality of carbonated candies within the cup.

30. The method of claim 28, wherein activating a second portion of the plurality of carbonated candies includes gas escaping from the second portion of the plurality of carbonated candies within a mouth of the consumer.
